(19) United States
(12) Patent Application Publication
(10) Pub. No.: US 2008/0127082 A1
(43) Pub. Date: May 29, 2008

(54) System and method for requirements-based application configuration

(76) Inventors: Miho Emil Birimisa, Karlsruhe (DE); Klaus-Peter Lang, Brackenheim-Botenheim (DE); Thomas Reiss, Heidelberg (DE); Andreas Schuh, Walldorf (DE); Robert Viehmann, Waghaeusel (DE); Werner Wolf, Wiesloch (DE)

Correspondence Address: SCHWEGMAN, LUNDBERG & WOESSNER/SAP, P.O. BOX 2938, MINNEAPOLIS, MN, 55402, US

(21) Appl. No.: 11/511,357

(22) Filed: Aug. 29, 2006

(51) Int. Cl. G06F 9/44

(52) U.S. Cl. 717/121

(57) ABSTRACT

A system and method for requirements-based application configuration. According to an embodiment of the invention, a configuration server provides a user interface to assess one or more requirements for an application based on a set of pre-defined application requirements, generates a configuration proposal based on the one or more assessed requirements, the configuration proposal specifying a subset of the set of pre-defined application requirements correlating with the one or more assessed requirements, stores the one or more assessed requirements in the data store, and generates one or more application configuration components correlating with the specified subset of pre-defined application requirements to implement the application in accordance with the one or more assessed requirements.

### BACKGROUND OF THE INVENTION

An organization's process of designing a new software application to be deployed on its computer system usually begins with a requirements document. This document is a high level “blueprint” which spells out certain features and functionality (e.g., processes and steps) to be implemented by an application for the organization. In many cases, rather than creating its own code from scratch, an organization may find it more cost-effective to purchase or license complex software that provides more functionality than the organization needs, but which can be configured to meet the organization's particular requirements.

Unfortunately, due to the complexity of such software it is usually necessary to hire a consultant or team of consultants skilled in the programming of the software to perform such a configuration. And once the software has been configured to the organization's particular requirements, it is extraordinarily difficult to reconfigure the software should the organization revise its requirements from those originally listed in the requirements document. This difficulty stems from the fact that current configuration tools provide access only to low-level settings and parameters of the software that are organized and structured independent of an organization's particular requirements as specified in the corresponding requirements document. Thus, the task of determining how to correctly configure those low-level settings and parameters in accordance with an organization's particular requirements falls to the skill and experience of the hired personnel.

Accordingly, there is a need in the art for a system and method that reduces the current difficulties associated with application configuration.

### BRIEF DESCRIPTION OF THE DRAWINGS

FIG. 1 is a block diagram that depicts a system architecture in accordance with an embodiment of the present invention.

FIG. 2 is a process flow diagram that depicts an application configuration process in accordance with an embodiment of the present invention.

FIG. 3 is a process flow diagram that depicts another application configuration process in accordance with an embodiment of the present invention.

FIG. 4 is a block diagram that depicts a scoping process in accordance with an embodiment of the present invention.

FIGS. 5-27 are screenshots that depict an application configuration user interface in accordance with an embodiment of the present invention.

FIG. 28 is a block diagram that depicts a computing device in accordance with an embodiment of the present invention.

### DETAILED DESCRIPTION

The present invention significantly reduces the current difficulties associated with application configuration by providing a configuration environment that directly links pre-defined application requirements to the generation of application configuration components which implement those requirements. In this manner, an organization can supply its application requirements to the configuration environment through a user-friendly graphical user interface, and the configuration environment can automatically generate and deploy the appropriate application configuration components.

Further, if, after deployment, an organization later revises its requirements through the graphical user interface, the configuration environment can automatically redeploy the application with the appropriate application configuration components. Not only is this aspect useful to organizations that revise their requirements after deployment, but it is also useful to those organizations who have not yet established specific requirements, but would like to explore and visualize what an application may look like based upon different available features and functionality.

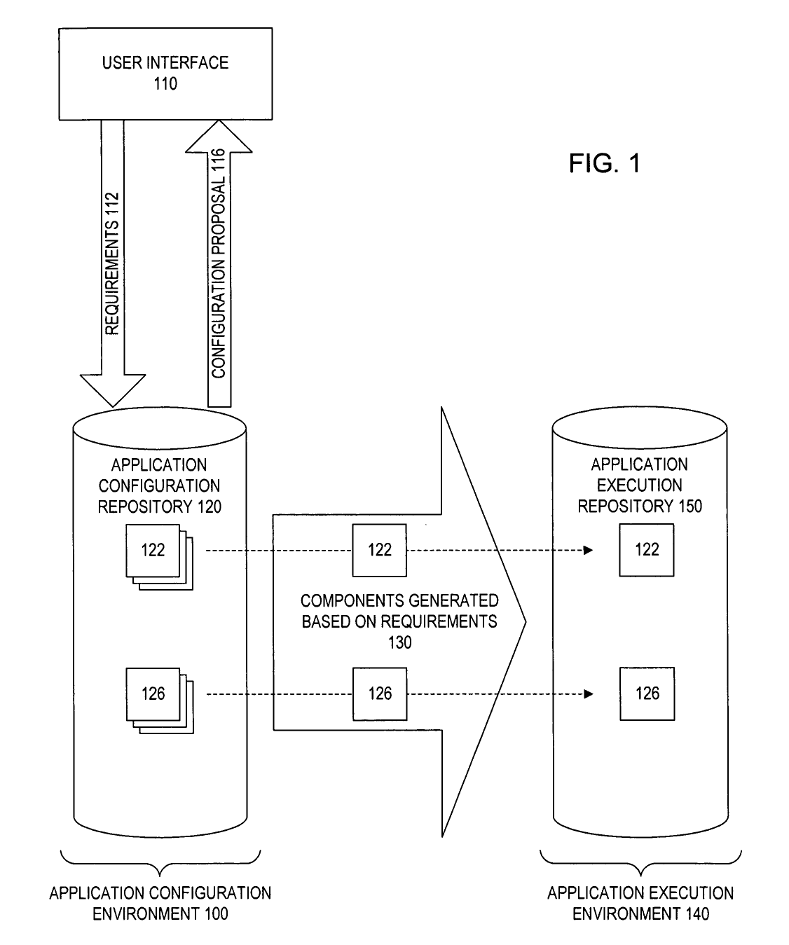

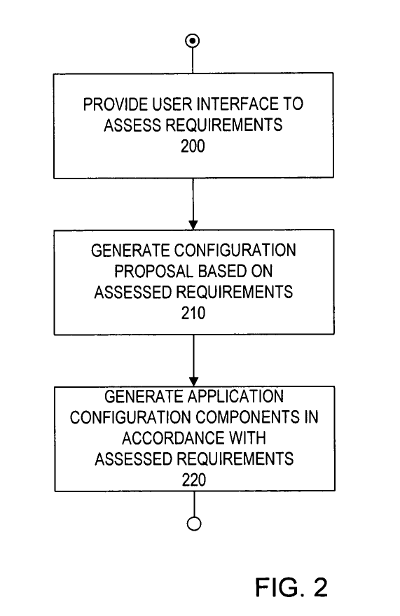

FIGS. 1 and 2 depict a system architecture and process in accordance with an embodiment of the invention. This architecture includes a user interface (110) and application configuration repository (120) within an application configuration environment (100), and an application execution repository (150) within an application execution environment (140). Based on a set of pre-defined application requirements (not shown), the application configuration environment (100) provides the user interface (110) to enable a user to assess one or more requirements for an application that the user wishes to configure (step 200).

Via the user interface (110), the user is able to assess application requirements (112) from which the application configuration environment (100) can generate a configuration proposal (116) for presentation to the user (step 210). The user may then accept the proposal or revise it in accordance with the user's requirements. Based on rules and/or mappings associated with the pre-defined application requirements, the application configuration environment (100) may generate application configuration components (e.g., 122 and 126) to be utilized for implementing the application in accordance with the assessed requirements (step 220). The application may then be deployed by copying the application configuration components from the application configuration repository (120) to the application execution repository (150).

A pre-defined application requirement may include any stored application requirement (e.g., a listing of one or more business packages, business topics or business options) that the application configuration environment (100) makes available to the user for selecting or choosing via the user interface (110). An application configuration component may take any electronic form (e.g., content, metadata, scripts, executable code, schemas, etc.) that can be utilized by an application execution environment (140) to implement an application based on the user-provided requirements. The rules and/or mappings associated with the pre-defined application requirements allows the application configuration environment (100) to directly generate the appropriate application configuration component(s) based on a user's requirements.

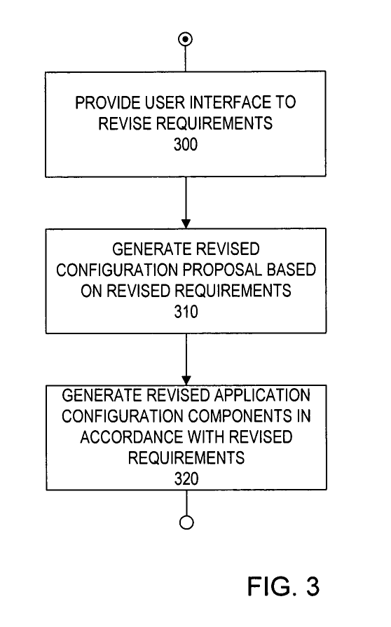

Additionally, by storing the user's requirements (e.g., in a customer profile), the application configuration environment (100) is able to retrieve them later if a user wishes to revise the user's deployed application based on different requirements. As shown in FIG. 3, the application configuration environment (100) allows a user to revise the user's requirements subsequent to generation and/or deployment of any application configuration components by providing the user interface (110) to enable the user to revise the user's requirements (step 300), generating a revised configuration proposal based on the revised requirements (step 310), and generating revised application configuration component(s) in accordance with the revised requirements (step 320) in a manner similar to that described above.

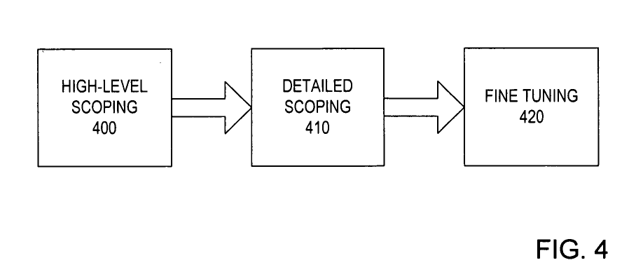

In providing the user interface (110) to assist the user in assessing the requirements for an application, the application configuration environment (100) may present a three level scoping methodology to the user as shown in FIG. 4 in accordance with an embodiment of the invention. The application configuration environment (100) may initially present the user with screens associated with high-level scoping (step 400), through which the user may select from a list of pre-defined business scenarios and/or job functions and answer specific key questions. Based on the user's response to the high-level scoping step (400), the application configuration environment (100) may generate a configuration proposal identifying pre-selected business packages and business topics in accordance with the user's requirements, and allow the user to revise the pre-selected packages and topics (step 410). Once the packages and topics are selected, the application configuration environment (100) may then allow the user to specify pre-defined business options associated with the selected packages and topics in accordance with the user's requirements (step 420).

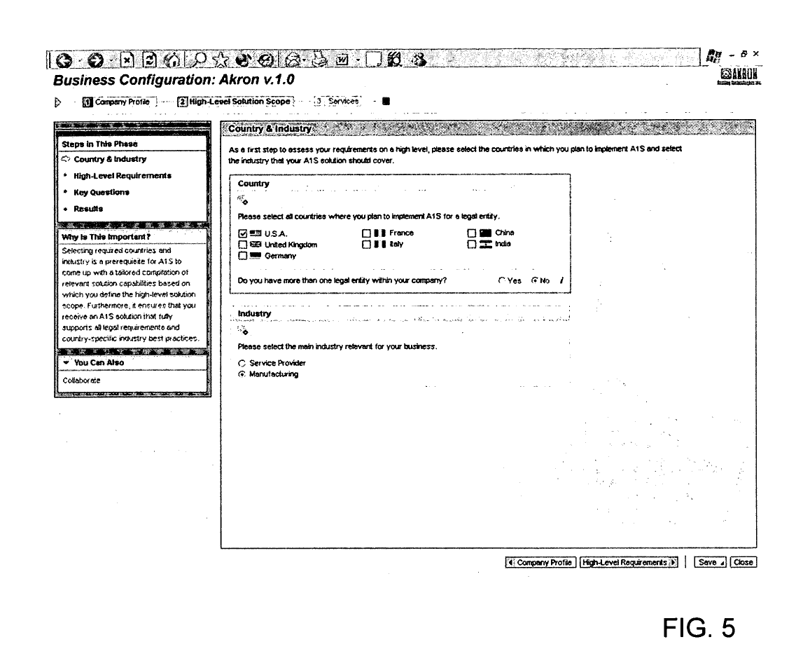

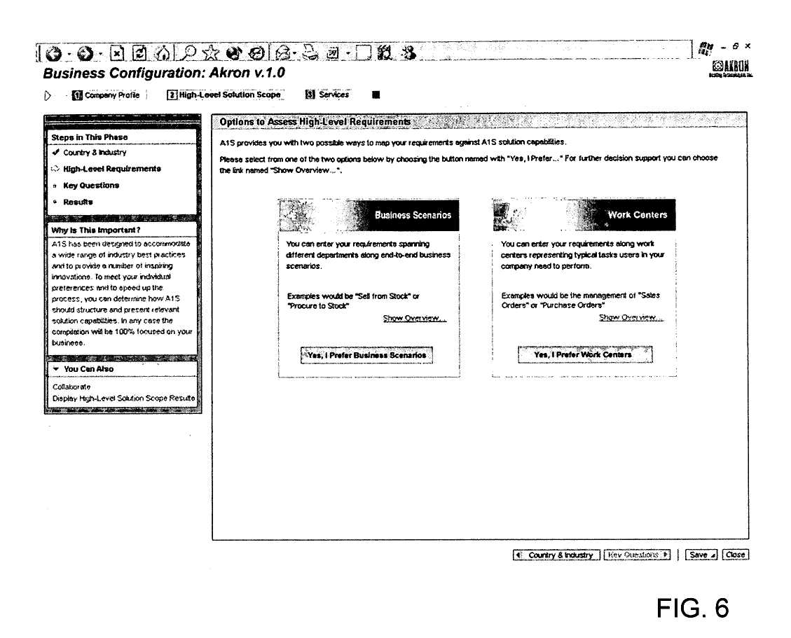

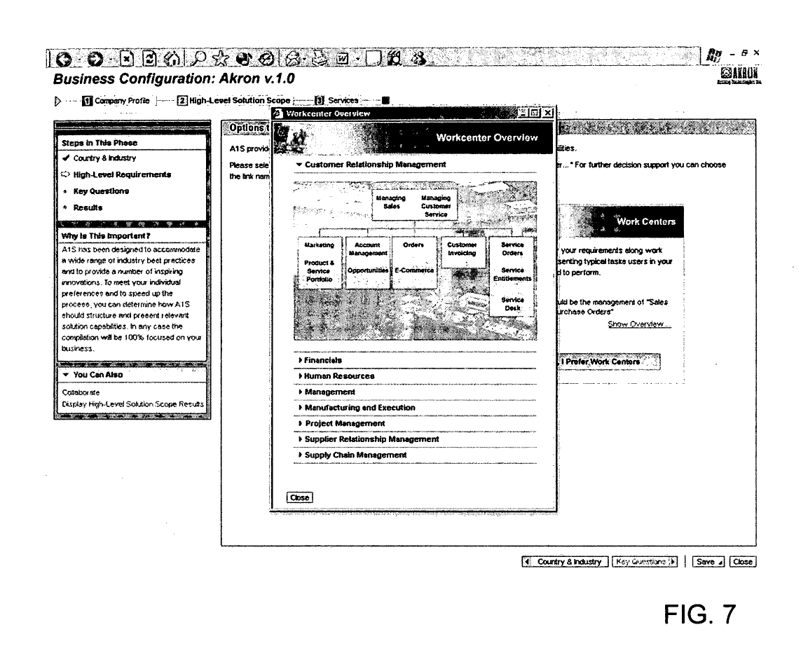

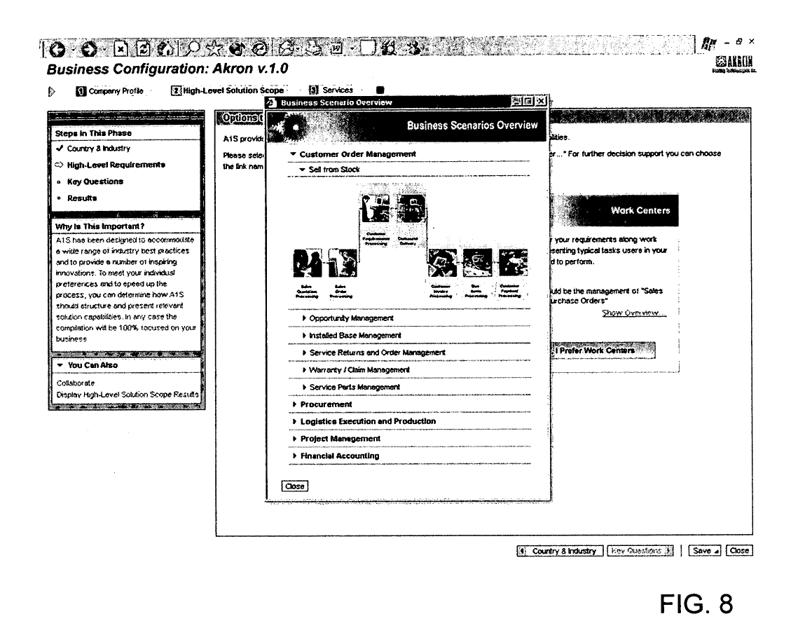

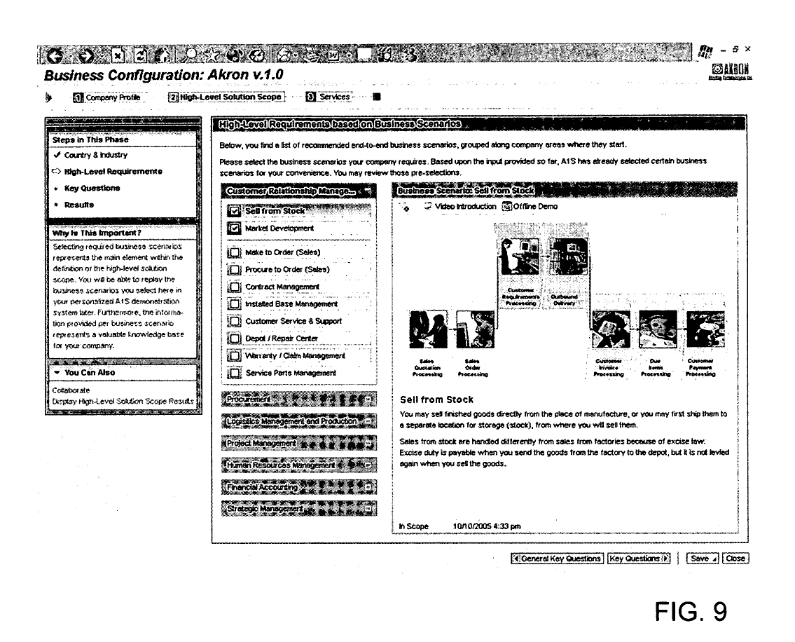

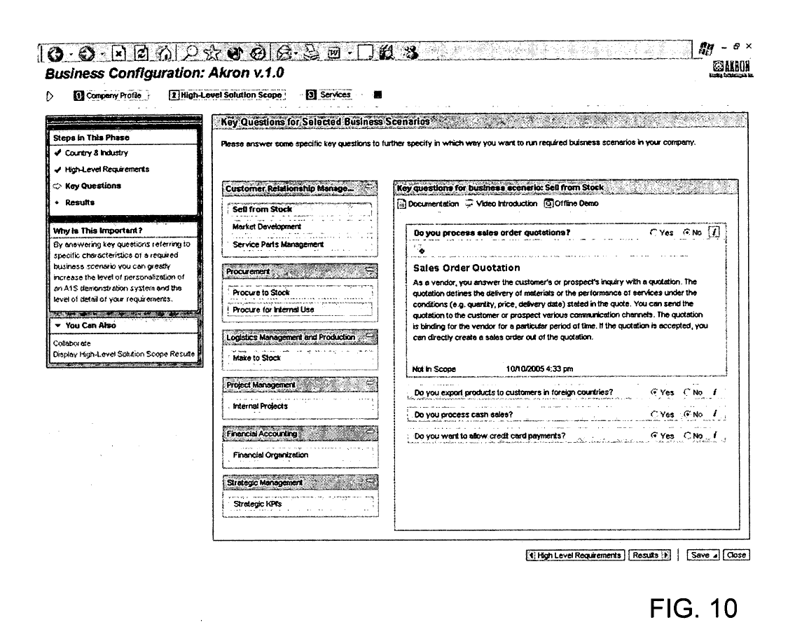

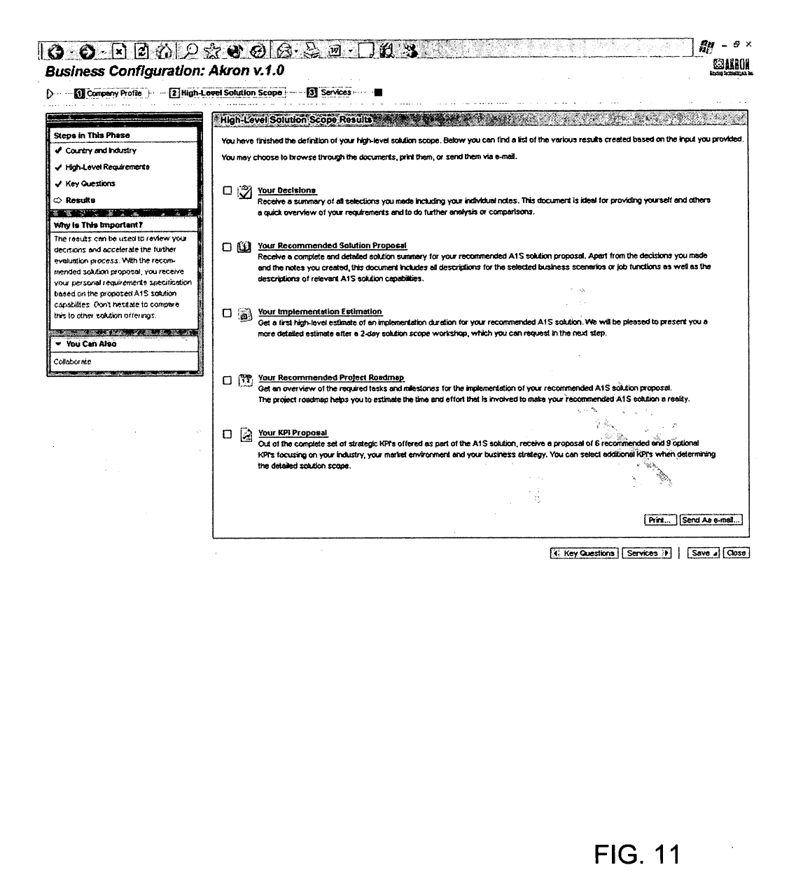

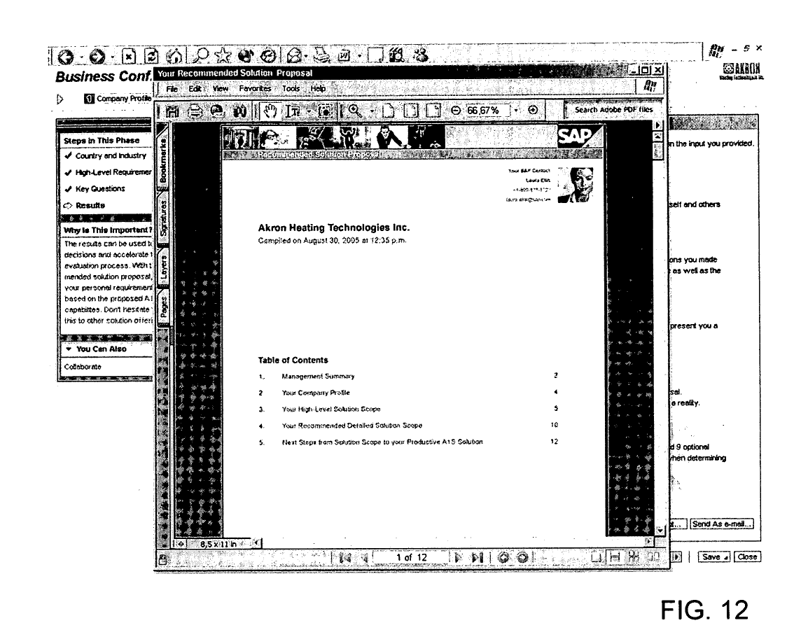

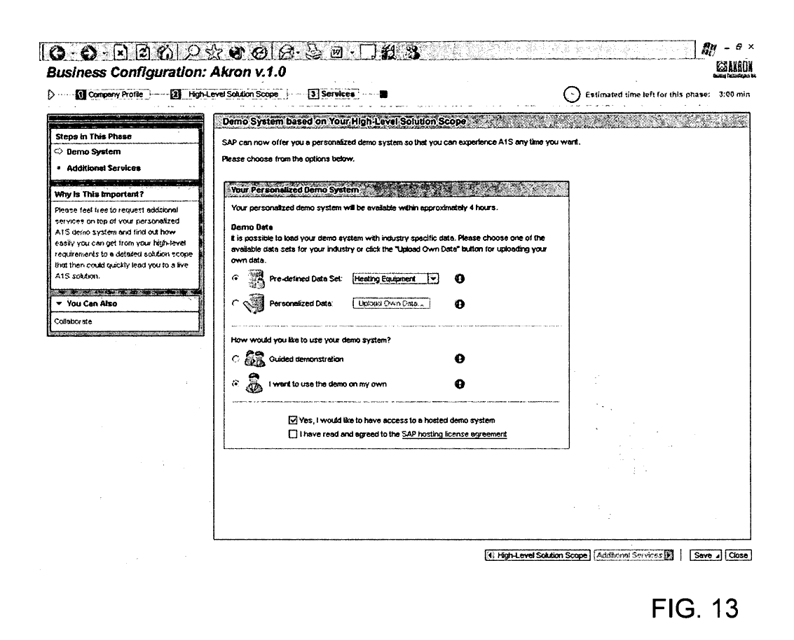

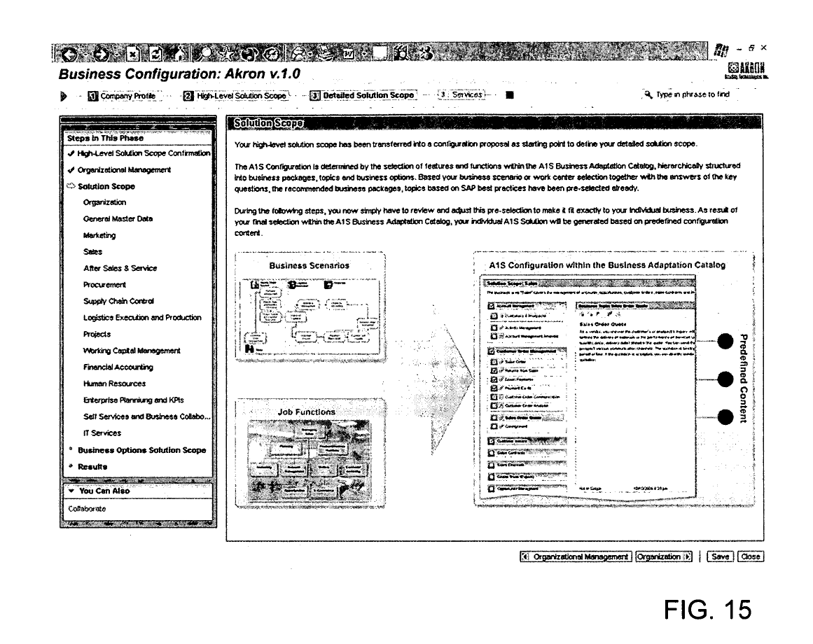

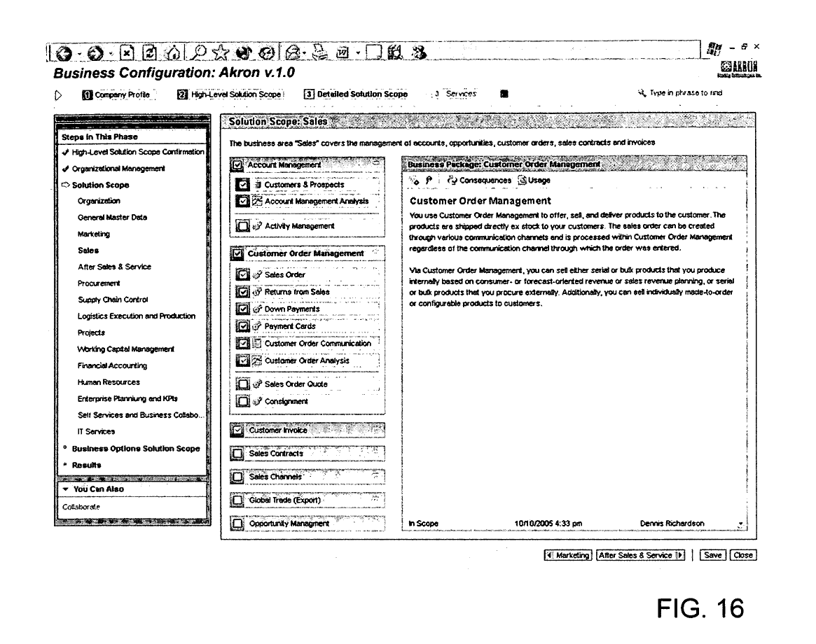

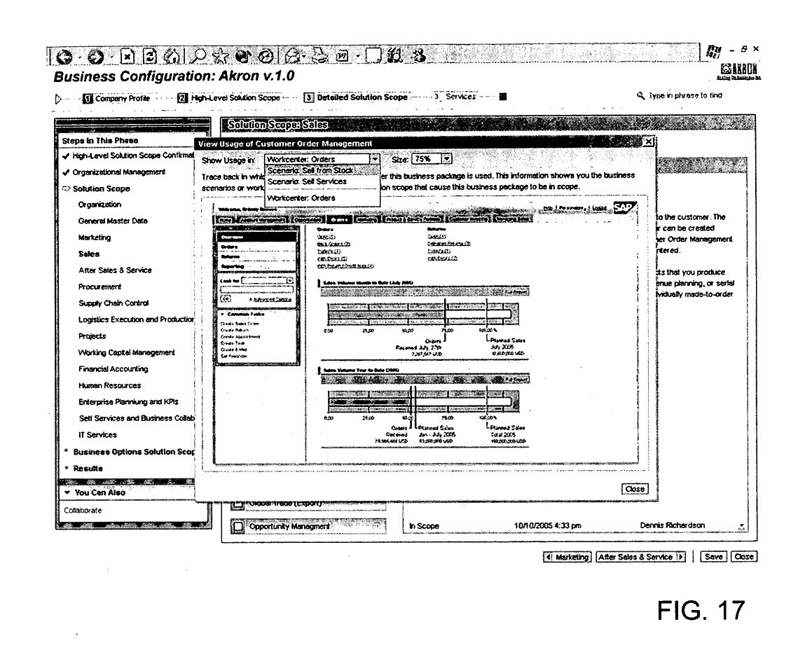

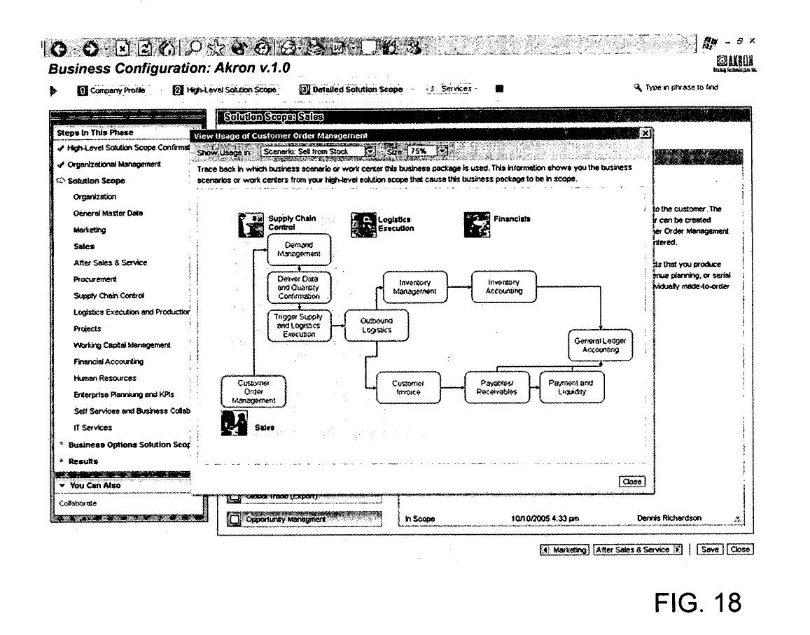

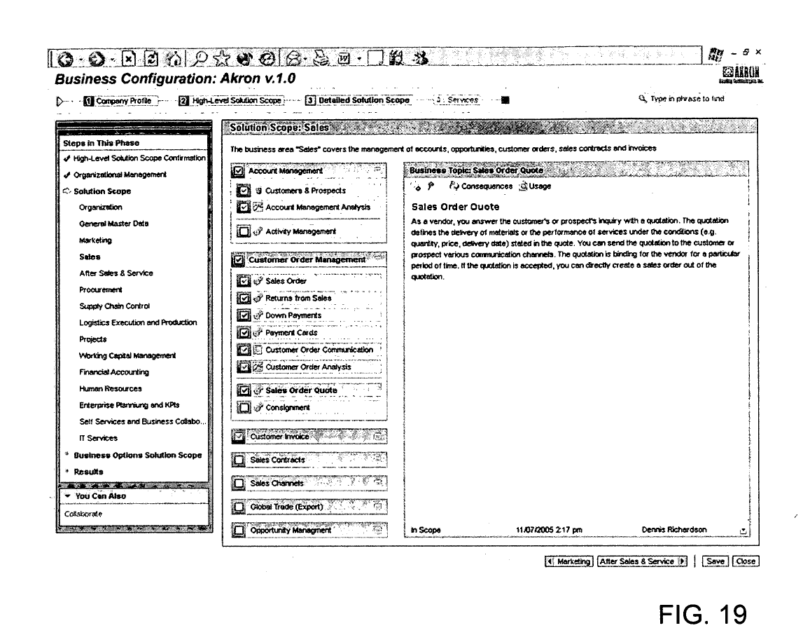

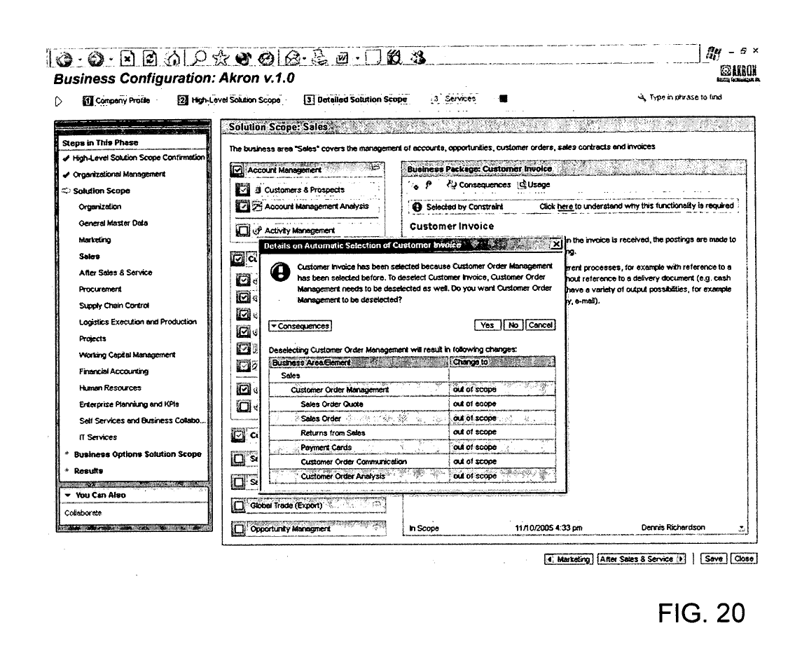

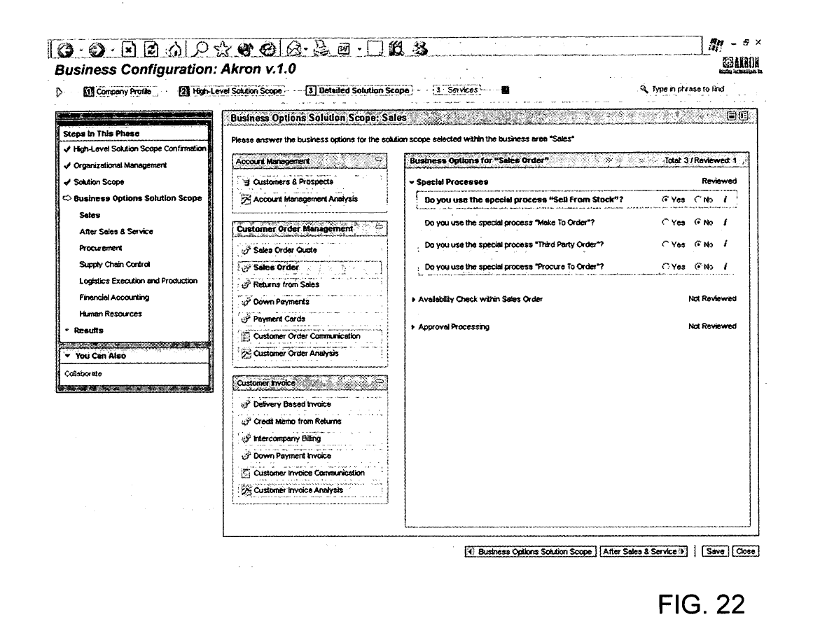

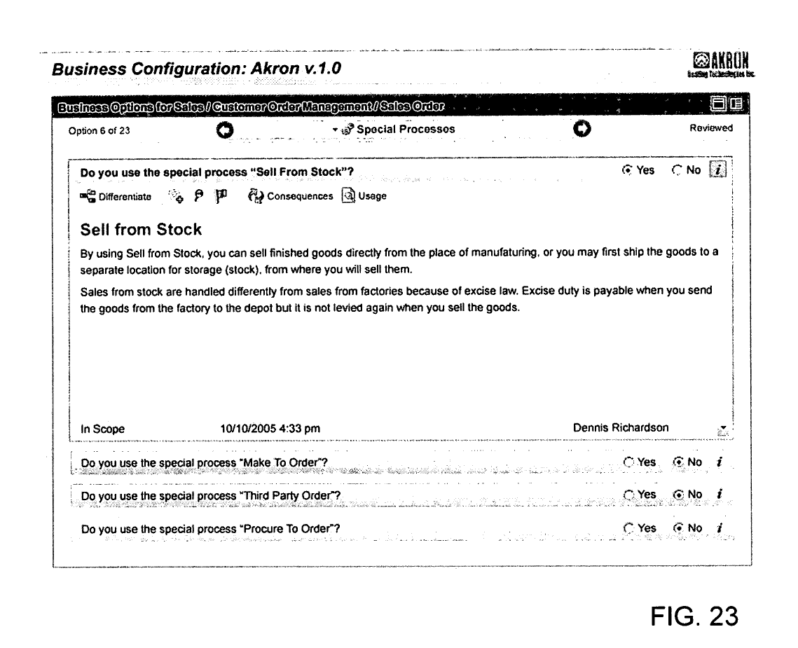

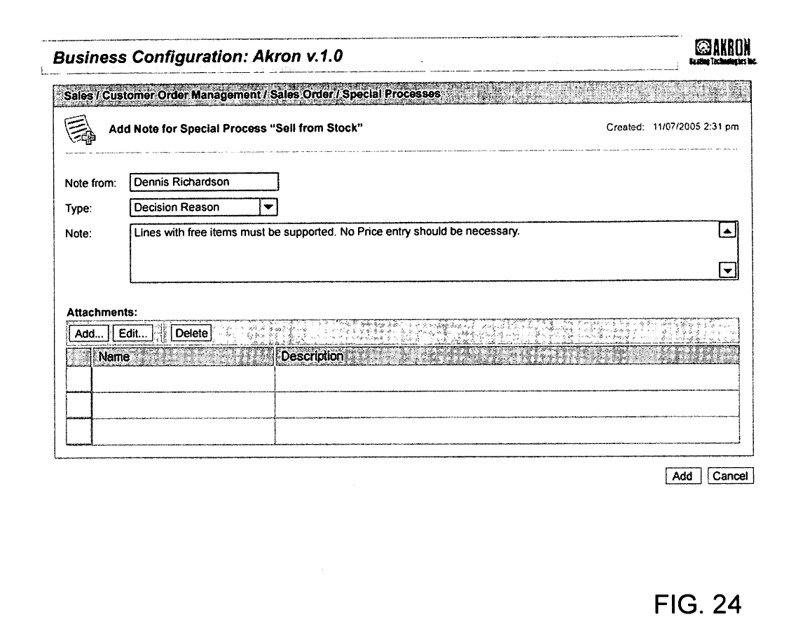

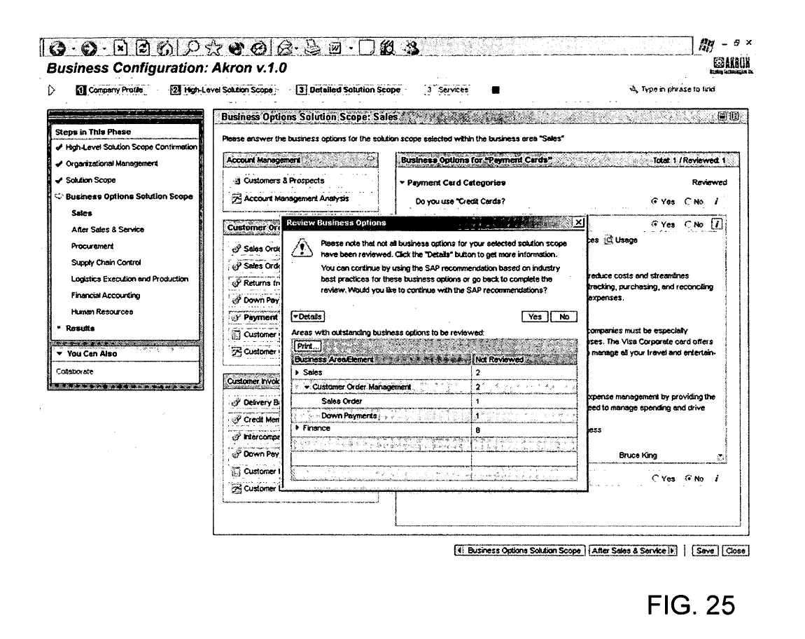

FIGS. 5-27 depict an application configuration user interface in accordance with an embodiment of the present invention. This embodiment covers a situation in which a company representative registers for a meeting with a business software provider representative to obtain information on a potential application that could be purchased to meet the company's requirements.

During this meeting, the business software provider representative offers the company representative to assess the company's high-level requirements using the configuration user interface (110) on her laptop in less than 45 minutes, for example (FIGS. 5-13). The information can then be turned into a fully comprehensive report including a detailed application proposal and an implementation roadmap as well as a list of the top strategic key performance indicators that A1S would automatically report on to give her a better control over her business.

Furthermore, the business software provider can use this information for basically any follow-up activity—without wasting time asking things the company representative has answered before. A key aspect to the company representative is the offer that after those 45 minutes, the company may receive free access to a company-specific demonstration system right after the information day (in 4 hours, for example) —and at the same time a great portion of a potential implementation could already be considered as done. Thus, it would not be a classic demo system to the company, but a preview of a live system.

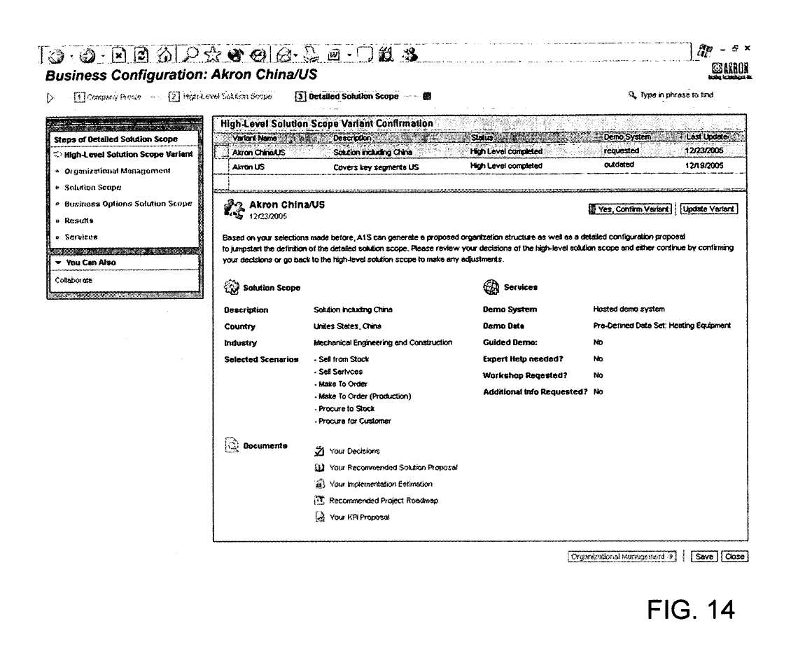

During a subsequent 2-day workshop (e.g., two week later), the business software provider representative, together with the company representative and possibly other company representatives, define the detailed scope for the potential application (FIGS. 14-20). During the first meeting the high-level application scope had been defined, and they stayed on a relatively high level and produced rapid results within just 45 minutes. Now they are defining the company blueprint in form of the detailed application scope.

The business software provider representative and the other workshop participants are introduced to the pre-defined application requirements (e.g., a “business adaptation catalog”)—a complete and transparent representation of the entire set of the business software provider's application capabilities. Basically any configuration of the business software provider's application can be triggered by making selections in this catalog—without the need to dig into the system details.

Based on the already defined high-level application scope, the system automatically determines all relevant application capabilities and highlights them accordingly. Now during the workshop, they go through the pre-selected features and verify them. Dependencies between different features are automatically controlled by the application configuration environment (100) during this process, always ensuring consistent business processes within the application.

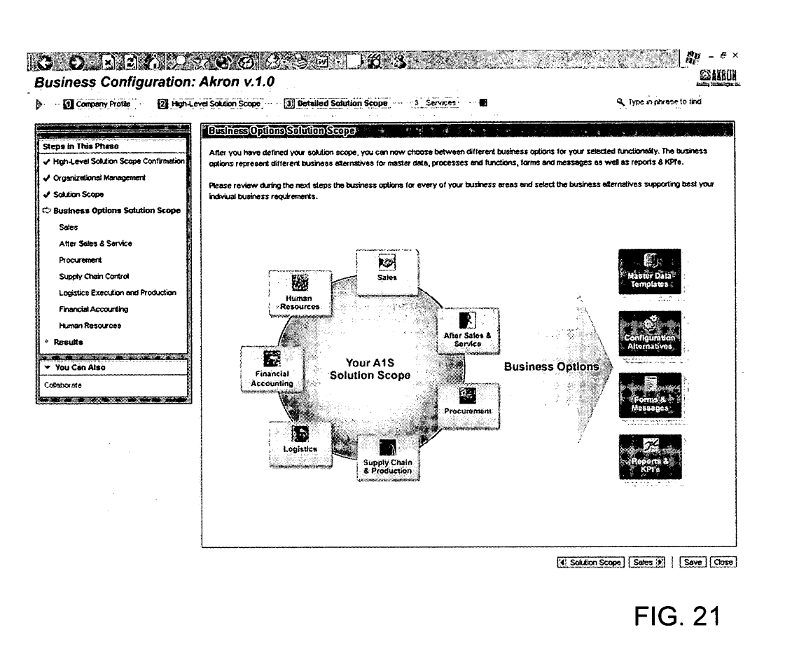

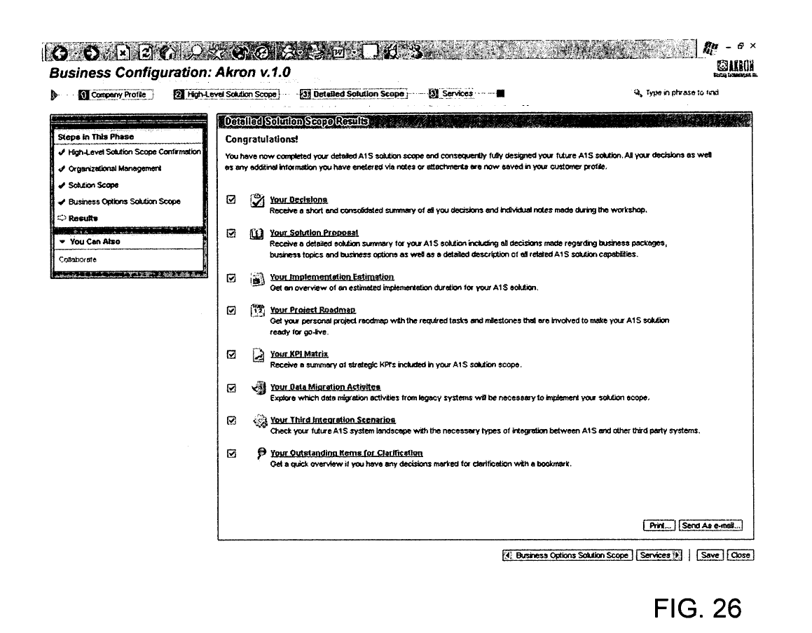

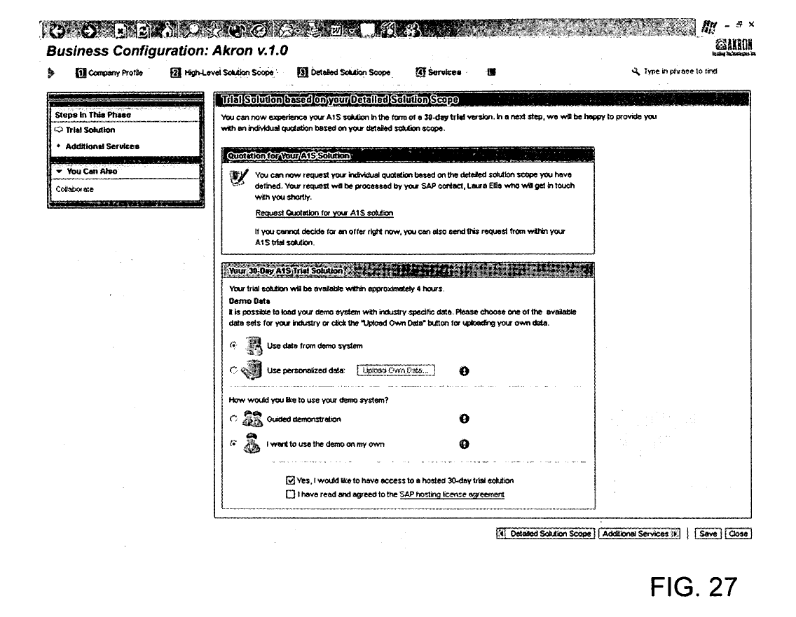

Once they are finished reviewing the pre-selected features and adding optional functionality to their application scope, the system automatically compiles a detailed list of business options for the selected scope (FIGS. 21-25). The business options are configuration alternatives representing different business variants as well as specific reports, forms or KPI's coming with the business software provider's application. Every business decision they make may automatically determine the relevant configuration of their potential application in the background. Finally, a compilation of all the decisions and results made regarding the detailed application scope is provided, as basis for a quotation as follow-up (FIGS. 26-27).

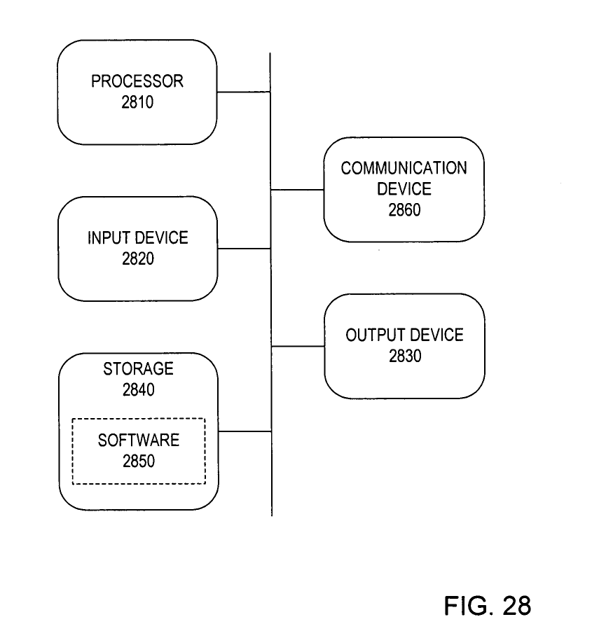

FIG. 28 illustrates the components of a basic computing device in accordance with an embodiment of the present invention. The computing device may be a personal computer, workstation, handheld personal digital assistant (“PDA”), server, or any other type of microprocessor-based device. The computing device may include one or more of a processor (2810), an input device (2820), an output device (2830), a storage (2840), and a communication device (2860).

The input device (2820) may include a keyboard, mouse, pen-operated touch screen or monitor, voice-recognition device, or any other device that provides input. Output device 2830 may include a monitor, printer, disk drive, speakers, or any other device that provides output.

The storage (2840) may include volatile and nonvolatile data storage, including one or more electrical, magnetic or optical memories such as a RAM, cache, hard drive, CD-ROM drive, tape drive or removable storage disk. The communication device (2860) may include a modem, network interface card, or any other device capable of transmitting and receiving signals over a network. The components of the computing device may be connected in any manner, such as via electrical bus or wirelessly.

The software (2850), which may be stored in the storage (2840) and executed by the processor (2810), may include, for example, the application programming that embodies the functionality of the present invention (e.g., as embodied in the application configuration environment (100)). The software (2850) may include a combination of client applications and enterprise servers such as an application server and a database server.

The computing device may communicate within or over any network, which may include any type of interconnected communication system, which may implement any communications protocol, and which may be secured by any security protocol. Any corresponding network links may include telephone lines, DSL, cable networks, T1 or T3 lines, wireless network connections, or any other arrangement that implements the transmission and reception of network signals.

The computing device may implement any operating system, such as Windows or UNIX. The software (2850) may be written in any programming language, such as ABAP, C, C++, Java or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention.

For example, software modules that implement the present invention such as the application configuration environment (100) may comprise several discrete modules that together still provide the same functionality, data specified in the referenced data stores (such as the application configuration repository (120) and the application execution repository (150), for example) may be spread over several databases and/or systems, and the process flow diagrams of FIGS. 2 and 3 may encompass combined steps or several intermediate steps that do not detract from the higher level functionality described therein.

What is claimed is:

1. A system for configuring an application, comprising:
a configuration server; and
a data store communicatively linked to the configuration server,
wherein the configuration server provides a user interface to assess one or more requirements for an application based on a set of pre-defined application requirements,
wherein the configuration server generates a configuration proposal based on the one or more assessed requirements, the configuration proposal specifying a subset of the set of pre-defined application requirements correlating with the one or more assessed requirements,
wherein the configuration server stores the one or more assessed requirements in the data store, and
wherein the configuration server generates one or more application configuration components correlating with the specified subset of pre-defined application requirements to implement the application in accordance with the one or more assessed requirements.

2. The system of claim 1,
wherein the configuration server retrieves, after the generating of the one or more application configuration components, the stored requirements from the data store,
wherein the configuration server provides the user interface to revise the stored requirements for the application based on the set of pre-defined application requirements,
wherein the configuration server generates a revised configuration proposal based on the revised requirements, the revised configuration proposal specifying a revised subset of the set of pre-defined application requirements correlating with the revised requirements, and
wherein the configuration server generates a revised one or more application configuration components correlating with the revised subset of pre-defined application requirements to implement the application in accordance with the revised requirements.

3. The system of claim 1, wherein the one or more assessed requirements are stored in association with a customer profile.

4. The system of claim 1, wherein pre-defined business scenarios are provided to a user for selection via the user interface to assist the user in assessing the one or more requirements for the application.

5. The system of claim 1, wherein pre-defined job functions are provided to a user for selection via the user interface to assist the user in assessing the one or more requirements for the application.

6. The system of claim 1, wherein the one or more application configuration components are deployed by being copied from an application configuration repository to an application execution repository.

7. The system of claim 1, wherein a plurality of business packages, business topics or business options are provided pre-selected to a user via the user interface to assist the user in assessing the one or more requirements for the application.

8. The system of claim 7,
wherein the configuration server determines, upon the user deselecting one or more of the plurality of pre-selected business packages, business topics or business options, whether to deselect any other of the pre-selected business packages, business topics or business options as a result of the user's deselection.

9. The system of claim 8,
wherein the configuration server requests, based on the determination, from the user via the user interface authorization to deselect other of the pre-selected business packages, business topics or business options as a result of the user's deselection.

10. A computer-implemented method for configuring an application, comprising:
providing a user interface to assess one or more requirements for an application based on a set of pre-defined application requirements;
generating a configuration proposal based on the one or more assessed requirements, the configuration proposal specifying a subset of the set of pre-defined application requirements correlating with the one or more assessed requirements; and
generating one or more application configuration components correlating with the specified subset of pre-defined application requirements to implement the application in accordance with the one or more assessed requirements.

11. The method of claim 10, further comprising:
providing, after the generating of the one or more application configuration components, the user interface to revise the assessed requirements for the application based on the set of pre-defined application requirements;
generating a revised configuration proposal based on the revised requirements, the revised configuration proposal specifying a revised subset of the set of pre-defined application requirements correlating with the revised requirements; and
generating a revised one or more application configuration components correlating with the revised subset of pre-defined application requirements to implement the application in accordance with the revised requirements.

12. The method of claim 10, further comprising:
storing the one or more assessed requirements in a data store in association with a customer profile.

13. The method of claim 10, wherein pre-defined business scenarios are provided to a user for selection via the user interface to assist the user in assessing the one or more requirements for the application.

14. The method of claim 10, wherein pre-defined job functions are provided to a user for selection via the user interface to assist the user in assessing the one or more requirements for the application.

15. The method of claim 10, wherein the one or more application configuration components are deployed by being copied from an application configuration repository to an application execution repository.

16. The method of claim 10, wherein a plurality of business packages, business topics or business options are provided pre-selected to a user via the user interface to assist the user in assessing the one or more requirements for the application.

17. The method of claim 16, further comprising:
determining, upon the user deselecting one or more of the plurality of pre-selected business packages, business topics or business options, whether to deselect any other of the pre-selected business packages, business topics or business options as a result of the user's deselection.

18. The method of claim 17, further comprising:
requesting, based on the determination, from the user via the user interface authorization to deselect other of the pre-selected business packages, business topics or business options as a result of the user's deselection.

19. A system for configuring an application, comprising:
means for providing a user interface to assess one or more requirements for an application based on a set of pre-defined application requirements;
means for generating a configuration proposal based on the one or more assessed requirements, the configuration proposal specifying a subset of the set of pre-defined application requirements correlating with the one or more assessed requirements; and
means for generating one or more application configuration components correlating with the specified subset of pre-defined application requirements to implement the application in accordance with the one or more assessed requirements.
